(19) United States
(12) Patent Application Publication
(10) Pub. No.: US 2017/0231432 A1
(43) Pub. Date: Aug. 17, 2017

(54) SELF-DEFROSTING BOTTOM INJECTION NOZZLE

(71) Applicants: Michael D. Newman, Hillsborough, NJ (US); Thomas Edward Kilburn, Pennsburg, PA (US)

(72) Inventors: Michael D. Newman, Hillsborough, NJ (US); Thomas Edward Kilburn, Pennsburg, PA (US)

(21) Appl. No.: 15/396,896

(22) Filed: Jan. 3, 2017

Related U.S. Application Data
(60) Provisional application No. 62/296,132, filed on Feb. 17, 2016.

(51) Int. Cl. A47J 43/07

(52) U.S. Cl. CPC A47J 43/0716

(57) ABSTRACT

A cryogen injection nozzle for a blender, comprising a housing having an internal chamber extending therethrough; a first tube extending along the internal chamber and having a first opening for delivering a cryogen to the blender; and a fluid flow apparatus mounted to the housing for introducing and removing a fluid flow at the internal chamber, the apparatus including a first pipe extending into the internal chamber for delivering the fluid flow to contact the first tube, and a second pipe extending a shorter distance into the internal chamber than the first pipe for removing the fluid flow from the internal chamber. Related methods are also provided.

### BACKGROUND

The present embodiments relate to apparatus and methods which injection cryogenic substances into blenders or mixers for cooling food products therein.

It is known to use nozzles to inject cryogenic substances, such as for example liquid nitrogen, into a blender for food products in order to chill same for subsequent processing. Such a process is referred to as bottom injection (BI), and the nozzles which inject the cryogenic substance are frequently referred to as bottom injection nozzles (BINs). Such known BINs are usually mounted at an exterior wall of the blender, and in fluid communication with an interior of the blender such that the cryogenic substance can be injected through the BIN and directly into the food being processed in the blender. Unfortunately, for most applications the product in the blender is a wet product which can be inadvertently drawn into an orifice of the BIN, thereby causing freezing of the orifice and clogging of same. When such clogging occurs, injection of the cryogen must be suspended until the nozzle orifice is cleared in order for further chilling in the blender to resume.

Known BINs are manufactured either from thick stainless steel or include a teflon sleeve. With either construction, both can suffer from the inadvertent freezing described above. That is, with the stainless steel nozzle, a large amount of heat from the blender wall can be transferred to the BIN which will remain extremely cold even after the injection cycle of the cryogen is complete. This can result in clogging of the nozzle orifice after the injection cycle. On the other hand, use of the teflon sleeve as part of the nozzle as mentioned above, does reduce an amount of the heat transfer from the blender wall, but nozzles having the teflon sleeve construction are prone to product migration from the blender to between the teflon sleeve and the housing of the nozzle which, upon exposure to the cryogenic temperatures, causes the housing of the nozzle to crack from thermal expansion and contraction.

Accordingly, what is needed is a BIN that can be used with a blender, but which will not have its orifice clogged, not have the housing crack, and not become inoperable under the effect of thermal expansion and contraction.

### SUMMARY

There is provided herein a cryogen injection nozzle for use with a blender, comprising a steel housing having an internal chamber therein for receiving a fluid; a first tube extending through the internal chamber for delivering a cryogen from the housing into the blender; a fluid inlet tube arranged to extend through the internal chamber to a first distance for delivering the fluid to said internal chamber and contacting the first tube; and a fluid outlet tube extending into the internal chamber to a second distance less than the first distance of the fluid inlet tube, the fluid outlet tube for removing the fluid from the internal chamber.

There is also provided herein a cryogen injection nozzle for a blender, comprising a housing having an internal chamber extending therethrough a first tube extending along the internal chamber and having a first opening for delivering a cryogen to the blender; and a fluid flow apparatus mounted to the housing for introducing and removing a fluid flow at the internal chamber, the apparatus including a first pipe extending into the internal chamber for delivering the fluid flow to contact the first tube, and a second pipe extending a shorter distance into the internal chamber than the first pipe for removing the fluid flow from the internal chamber.

There is further provided herein a method of introducing a cryogen into a blender, comprising positioning a cryogen delivery nozzle for delivering the cryogen to the blender; delivering the cryogen through a passageway in the nozzle to an interior of the blender; introducing a fluid having a higher temperature than the cryogen into the nozzle and external to the passageway for indirect warming of the cryogen in the passageway; and removing the fluid from the nozzle.

There is still further provided herein a method of defrosting a bottom injection nozzle providing a cryogen to a blender, comprising introducing a fluid into the nozzle at a first location proximate the blender; circulating the fluid for indirect contact with the cryogen for warming the nozzle and the cryogen; and removing the fluid from the nozzle at a second location further from the blender than the first location.

### BRIEF DESCRIPTION OF THE DRAWINGS

For a more complete understanding of the present invention, reference may be had to the following description of exemplary embodiments considered in connection with the accompanying drawing Figures, of which:

FIG. 1 shows a self-defrosting bottom injection nozzle apparatus according to the present embodiments for use with a blender;

FIG. 2 shows an enlarged view of a portion of the apparatus in FIG. 1;

FIG. 3 shows a more detailed side plan view of the bottom injection nozzle apparatus of FIG. 1;

FIG. 4 shows a more detailed side plan view partially in cross section of the bottom injection nozzle apparatus in FIG. 1; and

FIG. 5 shows a view of the bottom injection nozzle taken along the line 5-5 in FIGS. 3 and 4.

### DETAILED DESCRIPTION OF THE INVENTION

Before explaining the inventive embodiments in detail, it is to be understood that the invention is not limited in its application to the details of construction and arrangement of parts illustrated in the accompanying drawings, if any, since the invention is capable of other embodiments and being practiced or carried out in various ways. Also, it is to be understood that the phraseology or terminology employed herein is for the purpose of description and not of limitation.

In the following description, terms such as a horizontal, upright, vertical, above, below, beneath and the like, are to be used solely for the purpose of clarity illustrating the invention and should not be taken as words of limitation. The drawings are for the purpose of illustrating the invention and are not intended to be to scale.

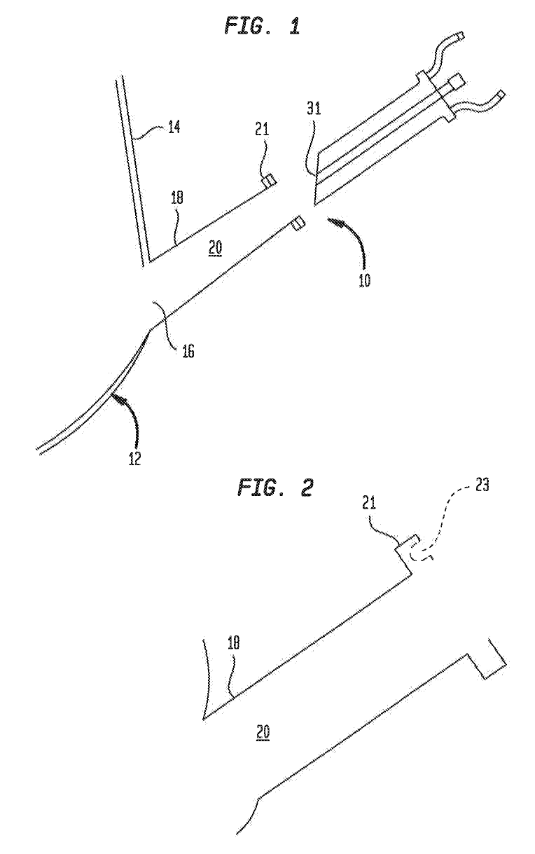

Referring to FIGS. 1 and 2, a bottom injection nozzle apparatus 10 of the present embodiments is shown for being removably mountable to a blender 12 or mixer. The apparatus can also be referred to herein as an “insert,” due to the construction and coaction with the blender 12. The blender 12 receives food products, most frequently wet food products, for mixing and being subjected to further processing thereafter. The blender 12 includes a sidewall 14 which is constructed with a port 16 or hole therein for providing fluid communication with substances at an interior of the blender 12. The food products (not shown) very frequently need to be chilled quickly, effectively and cost-efficiently. Chilling is done with a cryogen such as for example liquid nitrogen (LIN).

The blender sidewall 14 may be constructed with a cylindrical sleeve 18 or shell extending from the sidewall and having an internal passageway 20 in communication with the port 16. The sleeve 18 can form part of the apparatus 10. By way of example only, the sleeve 18 has a cylindrical shape with a circular cross section, although it is understood that other shapes and cross sections may be used for the sleeve. The sleeve 18 may be welded to the sidewall 14 so that the internal passageway 20 is in registration with the port 16 or alternatively, the sleeve may be formed integral with the sidewall 14. A diameter of the cylindrical sleeve 18 can be for example approximately 2 inches (5.1 cm). An end of the sleeve 18 is formed with a flange 21 or bracket extending around the sleeve. The flange 21 includes a detent 23 or space formed therein for a purpose to be described hereinafter.

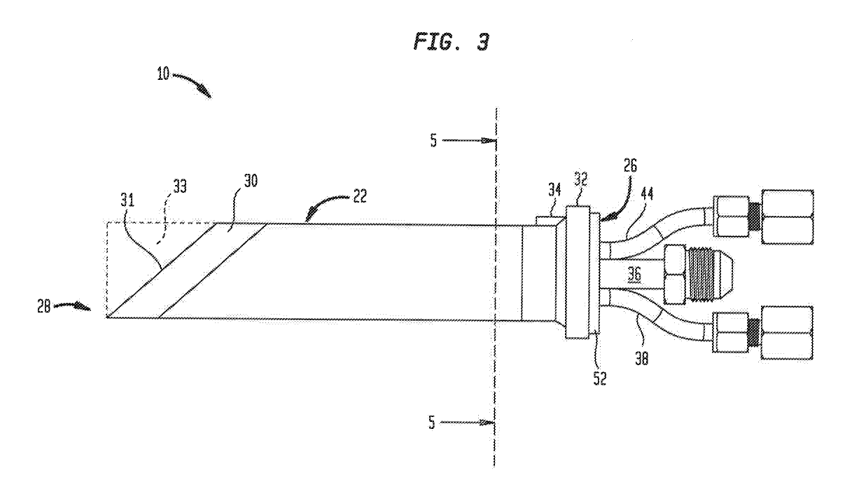

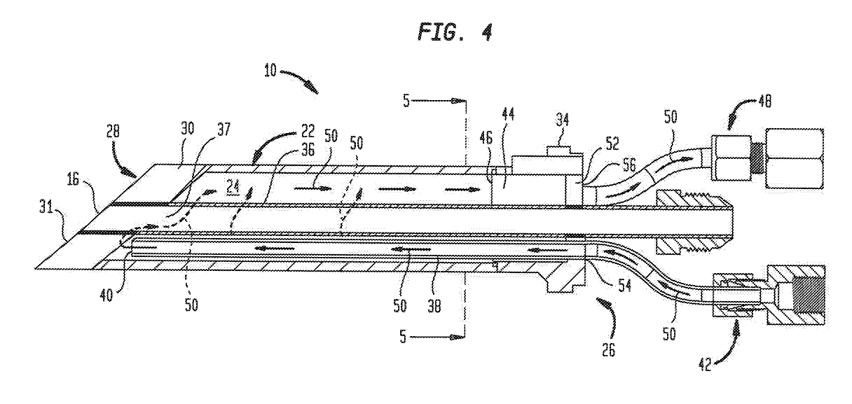

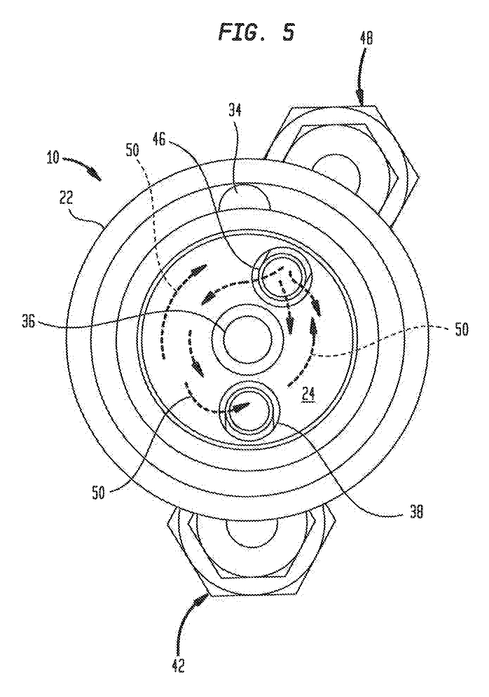

Referring also to FIGS. 3-5 there is shown more detail of the apparatus 10 for use with the blender 12. The apparatus 10 functions as a nozzle insert to be releasably received in the passageway 20 of the cylindrical sleeve 18. The apparatus 10 includes a stainless steel housing 22 or tube having an internal chamber 24 therein extending along a length of the housing. The housing 22 has a proximate end 26 and a distal end 28 at an opposed end of the housing. The distal end 28 is inserted first into the internal passageway 20 of the sleeve 18. The distal end 28 is provided with an end portion 30 being approximately 0.5 inches (1.25 cm) thick and which is constructed from the same material (stainless steel) as the housing 22. A region 33 can be ground or cut-away so that an angled end surface 31 substantially conforms to a shape of the blender sidewall 14 so that the distal end sits flush with and conforms to the sidewall 14. The view in FIG. 3 shows the housing 22.

The proximate end 26 of the housing 22 includes an elevated flange 32 for being removably mounted to the flange 21 or bracket of the cylindrical sleeve 18 The flange 32 includes a guide pin 34 protruding therefrom facing toward the distal end 28. The guide pin 34 is sized and shaped to be releasably received in the detent 23 to position or seat the housing 22 in the passageway 20 of the sleeve 18.

The apparatus 10 includes a stainless steel tube 36 extending through the internal chamber 24 and being in fluid communication at one end with the port 16 of the blender 12, and at an opposite end being constructed for releasable engagement to a remote source of cryogen such as nitrogen, as shown in FIG. 3. The tube 36 may be constructed with a thin wall in order to minimize thermal mass of the tube and allow for quick defrosting of same depending upon the flow rate velocity of water in the internal chamber 24 as described hereinafter. As shown in FIG. 3, an end of tube 36 extending from the proximate end 26 of the housing 22 is threaded for releasable engagement to the source of cryogen (not shown) provided from a remote location.

A water delivery tube 38 is also disposed in the internal chamber 24 and spaced apart from the stainless steel tube 36. The water delivery tube 38 extends along substantially the entire length of the internal chamber 24 and has an outlet 40 opening close to the distal end 28 of the housing 22. An opposite end of the water delivery tube 38 is mechanically connected to a water connection assembly shown generally at 42.

A water outlet tube 44 is also disposed in the internal chamber 24. The outlet tube 44 however has an opening 46 positioned substantially closer to the proximate end 26 of the housing 22, for a purpose to be described hereinafter. As shown in FIG. 3, water flow 50 in the internal chamber 24 is introduced through the water tube 38 into the internal chamber for contacting the stainless steel tube 36 (which delivers the cryogen) and thereafter, being removed from the internal chamber through the opening 46 of the water outlet tube 44 to a remote location. The water outlet tube 44 external to the proximate end 26 is mechanically mounted for releasable engagement to a water connection shown generally at 48.

The internal chamber 24 functions as an annular space within the housing 22 and through which a low to high velocity flow of water introduced into the space can be achieved. The proximate end 26 of the housing 22 can be sealed with an end cap 52. The end cap 52 is provided with holes 54, 56 or apertures through which a respective one of the tubes 38, 44 is accessible.

An alternative embodiment of the apparatus 10 is constructed with the end cap 52 having the water delivery tube 38 and the water outlet tube 44 mounted thereto as a composite unit for being removably mounted to the housing 22, such as by bayonet fitting, screw thread fitting, or other mechanical mounting assemblies.

In operation and when it is necessary to introduce a cryogenic substance such as liquid nitrogen (LIN) for example into the blender 12, the BIN apparatus 10 is inserted into the internal passageway 20 of the cylindrical sleeve 18 such that the elevated flange 32 of the apparatus and the flange bracket 21 of the sleeve are in contact for being releasably engaged to each other. Such construction provides for the angled end surface 31 to bring the distal end 28 into position such that the stainless steel tube 36 passageway therein is in fluid communication with the port 16 of the blender 12. The cryogenic substance is introduced through the passageway of the stainless steel tube 36 and into the blender and, after a select period of time, a water flow can be introduced into the internal chamber 24 to prevent any condensation from freezing which would clog the orifice 37 of the stainless steel tube and prevent it from delivering the cryogen to the blender. The water flow 50 is delivered to the water delivery tube 38 as shown and upon exit from the water delivery tube outlet 40 floods the internal chamber 24 and contacts substantially the entire exterior surface area of the cryogen tube 36 to defrost and thaw any condensate so that the orifice 37 and the port 16 of the blender 12 do not become clogged with frozen condensate or frozen food product. Thereafter, the water flow 50 is channeled to the opening 46 of the water outlet tube 44 which opens at the internal chamber 24 such that the water flow can be exhausted from the internal chamber through the water connection 48 to a remote location which could include, for example, recycling of the water flow 50.

Regarding dimensions, by way of example only, an interior Length L1 of the internal chamber 24 as shown in FIG. 3 can be 7 inches (17.8 cm).

The bottom injection nozzle apparatus 10 of the present embodiments can be replaced without welding same to a blender 12, thereby resulting in a minimal amount of labor in order to quickly replace or substitute one bottom injection nozzle for another, depending upon the blending operation and product being blended. The high velocity water flow 50 through the nozzle 10 reduces flow rate requirements of the water and therefore maximizes each transfer at the nozzle. There is no clogging or plugging of the nozzle orifice with the product being blended or frozen condensate. There are no plastic or teflon parts to crack or break when exposed to the cryogenic substances. A straight bore for the nitrogen injection tube or an expanding bore nozzle allows for the embodiments to be clean-in-place (CIP), ie a user of the apparatus 10 can clean the nozzle by injecting hot, high pressure water, steam or cleaning agents through the nozzle without having to remove the nozzle.

Certain embodiments herein also include a nozzle comprising an open ended sleeve mountable to the blender, the sleeve including an internal volume sized and shaped to releasably receive the housing, and a port in fluid communication with an interior of the blender and the first opening.

Certain embodiments include a nozzle, wherein the fluid flow comprises a flow of water.

Certain embodiments include a nozzle, wherein the cryogen comprises liquid nitrogen (LIN), and the fluid comprises water (H₂O).

Certain embodiments include a method, wherein the cryogen comprises LIN and the fluid comprises H₂O.

It will be understood that the embodiments described herein are merely exemplary, and that a person skilled in the art may make variations and modifications without departing from the spirit and scope of the invention. All such variations and modifications are intended to be included within the scope of the invention as described herein and in the appended claims. It should be understood that the embodiments described above are not only in the alternative, but can be combined.

What is claimed is:

1. A cryogen injection nozzle for use with a blender, comprising:
a steel housing having an internal chamber therein for receiving a fluid;
a first tube extending through the internal chamber for delivering a cryogen from the housing into the blender;
a fluid inlet tube arranged to extend through the internal chamber to a first distance for delivering the fluid to said internal chamber and contacting the first tube; and
a fluid outlet tube extending into the internal chamber to a second distance less than the first distance of the fluid inlet tube, the fluid outlet tube for removing the fluid from the internal chamber.

2. A cryogen injection nozzle for a blender, comprising:
a housing having an internal chamber extending therethrough;
a first tube extending along the internal chamber and having a first opening for delivering a cryogen to the blender; and
a fluid flow apparatus mounted to the housing for introducing and removing a fluid flow at the internal chamber, the apparatus including a first pipe extending into the internal chamber for delivering the fluid flow to contact the first tube, and
a second pipe extending a shorter distance into the internal chamber than the first pipe for removing the fluid flow from the internal chamber.

3. The nozzle of claim 2, further comprising an open ended sleeve mountable to the blender, the sleeve including an internal volume sized and shaped to releasably receive the housing, and a port in fluid communication with an interior of the blender and the first opening.

4. The nozzle of claim 2, wherein the fluid flow comprises a flow of water.

5. A method of introducing a cryogen into a blender, comprising:
positioning a cryogen delivery nozzle for delivering the cryogen to the blender;
delivering the cryogen through a passageway in the nozzle to an interior of the blender;
introducing a fluid having a higher temperature than the cryogen into the nozzle and external to the passageway for indirect warming of the cryogen in the passageway; and
removing the fluid from the nozzle.

6. The method of claim 5, wherein the cryogen comprises liquid nitrogen (LIN), and the fluid comprises water (H₂O).

7. A method of defrosting a bottom injection nozzle providing a cryogen to a blender, comprising:
introducing a fluid into the nozzle at a first location proximate the blender;
circulating the fluid for indirect contact with the cryogen for warming the nozzle and the cryogen; and
removing the fluid from the nozzle at a second location further from the blender than the first location.

8. The method of claim 7, wherein the cryogen comprises LIN and the fluid comprises H₂O.
